(19) United States
(12) Patent Application Publication
(10) Pub. No.: US 2023/0313658 A1
(43) Pub. Date: Oct. 5, 2023

(54) STRENGTHENING FRACTURE TIPS FOR PRECISION FRACTURING

(71) Applicant: CONOCOPHILLIPS COMPANY, Houston, TX (US)

(72) Inventor: Vibhas PANDEY, Houston, TX (US)

(73) Assignee: CONOCOPHILLIPS COMPANY, Houston, TX (US)

(21) Appl. No.: 18/174,104

(22) Filed: Feb. 24, 2023

Related U.S. Application Data
(60) Provisional application No. 63/318,843, filed on Mar. 11, 2022.

(51) Int. Cl. E21B 43/267; E21B 43/16; G01V 99/00

(52) U.S. Cl. CPC E21B 43/267; E21B 43/16; G01V 99/005; E21B 2200/20

(57) ABSTRACT

A method of fracturing a reservoir wherein the main fracture stimulation treatment is preceded by depositing non dissolving solids into fracture tips where excessive downward or upward fracture growth is not desired, thereby controlling fracture geometry. The method thereby increases production of a fluid, such as water, oil or gas, from said reservoir, and avoids fracture propagation out of the pay-zone into undesirable zones.

### PRIOR RELATED APPLICATIONS

This application claims priority to U.S. Ser. No. 63/318,843, filed Mar. 11, 2022, and incorporated by reference in its entirety for all purposes.

### FEDERALLY SPONSORED RESEARCH STATEMENT

Not applicable.

### FIELD OF THE DISCLOSURE

The disclosure generally relates to methods, devices and systems for fracturing hydrocarbon formations to improve the production of hydrocarbons. In particular, fracture tips are strengthened with solid deposits in the tips where needed to control fracture propagation.

### BACKGROUND OF THE DISCLOSURE

In many formations, chemical and/or physical processes alter the reservoir rock over geologic time. Sometimes, these diagenetic processes restrict the openings in the rock and reduce the ability of fluids to flow through the rock. If fluids cannot flow, it will be difficult to produce oil, gas, or water from a well. Thus, low permeability reservoirs are often fractured to increase their permeability and thereby increase the production of fluids.

Hydraulic fracturing is the process of pumping fluid into a wellbore at an injection rate that is too high for the formation to accept without breaking. During injection, the resistance to flow in the formation increases and the pressure in the wellbore increases to a value called the break-down pressure, that is the sum of the in situ compressive stress and the strength of the formation. Once the formation “breaks down,” a fracture is formed, and injected fluid can then flow through the fracture and be produced.

In general, hydraulic fracture treatments are used to increase the productivity index of a producing well or the injectivity index of an injection well. The productivity index defines the rate at which oil or gas can be produced at a given pressure differential between the reservoir and the wellbore, while the injectivity index refers to the rate at which fluid can be injected into a well at a given pressure differential.

During a typical fracking job, a fluid not containing any solid (called the “pad”) is injected first, until the fracture is wide enough to accept a propping agent. The pad fluid plus propping agent are injected next. The purpose of the propping agent is to keep the fracture open once the pumping operation ceases. In deep reservoirs, man-made ceramic beads are used to hold open or “prop” the fracture (see e.g., FIG. 1). In shallow reservoirs, sand is normally used as the propping agent. In carbonate rich plays, the fractures can be acid etched instead of being propped open. Usually, this is followed by a final flush, but there are many variations on these basic techniques.

Fractures may occur in different directions, have different lengths and widths and may intersect or branch, providing a complex pattern of fractures. “Hydraulic fracture geometry” refers to the length, direction and overall pattern of fractures. Longitudinal fractures, for example, generally travel along the well axis and typically have excellent connectivity with the well, but don't reach very far into the reservoir. Transverse fracturing has the potential to reach further into the reservoir since fracture direction is perpendicular to the wellbore, and many transverse fractures are bi-winged fractures proceeding in opposite directions from the initiation point.

The resulting geometry from a fracking job is a complex function of initial reservoir stress conditions (global and local), reservoir rock properties such as heterogeneous and anisotropic rock mechanical properties (Young's modulus and Poisson's ratio), permeability, porosity, the preexisting natural fracture system, and operational conditions such as injection rate, volume, and pressure.

It is important to place as many fractures as necessary to effectively deplete the reservoirs. This is particularly true for gas shales because the typical shale reservoir in situ permeability is quite low at 100˜400 nano-darcy. Multiple transverse fractures are thus created with multi-stage fracturing treatments (either open hole completion or cemented/perforated casing hole completion). For casing hole completion, multiple cluster perforations are typically used in any single stage to initiate multiple transverse fractures.

However, the success to date in stimulating and producing low-permeability reservoirs with multiple transverse fractures does not imply that the process is optimized. The industry's experience in designing and implementing transverse fractures in formations remains at an early stage, and significant improvements in well productivity and profitability are still hoped for.

Indeed, problems include poor vertical height of fractures, which tend to be limited because the fractures do not like to grow through the highly laminated sequences typical of shale. Further, there is also evidence of fracture collapse. Evaluation of 200 field trials with different frac designs and 143 trials in which restimulation treatments were documented indicated that fractures frequently fail to provide durable, highly conductive pathways for hydrocarbons to flow.

Another challenge with transverse fractures is the extremely limited intersection area between the well bore and the fracture. As shown in FIG. 2, a longitudinal fracture that grows along the axis of the well bore can provide a very large intersection between the well and fracture. However, the transverse fracture has very limited contact with the wellbore. This tends to cause choking near the wellbore, as all the fluid has to reach the wellbore through an increasingly constrained space.

For example, a 5,000-foot open-hole lateral drilled in the direction of the maximum horizontal stress may achieve 10,000 linear feet of intersection with a longitudinal fracture. However, if a transverse fracture is created, the area of intersection is reduced drastically. For a typical six-inch diameter hole, the well bore circumference provides merely 1.6 feet of linear intersection. For both fractures to produce at the same rate, oil must travel 6,250 times faster in the transverse fracture because of converging flow geometry. When considering that pressure losses are related to velocity-squared, the near-well-bore pressure losses in the transverse fracture are increased by a factor of 6,2502 or 39 million!

Additionally, because transverse fractures suffer from an extremely small area of intersection between the well bore and fracture, they are more vulnerable to damage related to inadequate proppant quality, low proppant concentration, overflushing, or proppant flow back.

Although transverse fracturing is very promising and already providing many successful reservoir developments, there is a need to further develop hydraulic fracture methodology. Thus, although great strides have been made in controlling fracture geometry, there is considerable room for improvement and this invention provides one or more of such improvements.

### SUMMARY OF THE DISCLOSURE

Fracture length is often referred to as half-length for bi-winged transverse fracture. The half-length of a hydraulic fracture is critical to well performance for most low to medium permeability reservoirs and is generally understood and modeled as an artifact of material balance between the fracture fluid injected to create a fracture and the amount of fluid lost to the surrounding rock mass or formation.

In early phase of fracture propagation, the fractures are more prone to growing vertically (and extending laterally to some extent) from the point of injection, until strong barriers such as those imposed by in situ stresses are encountered in vertical direction that act to contain fracture growth. On the other hand, the fracture half-length will increase if (a) leakoff of the fracturing fluid into the formation is controlled, and (b) if vertical growth of fracture stops or becomes near stationary once reaching such barriers.

Thus, in cases where top and bottom tip of fractures are bound by stress barriers, there is higher probability to achieve the desired fracture half-length as long as those stress barriers are not breached and as long as leakoff is controlled to generate required fracture pressure.

Conversely, the absence of barriers can lead to uncontrollable fracture height where fracture half-lengths may be compromised. Furthermore, if the fracture height is not controlled, the fracture can grow out of the pay zone and lead to reduced fracture conductivity, which may negatively affect overall well performance.

The proposed innovation is aimed at strengthening the fracture tips by packing the tip with solid, non-dissolving particulate matter that functions to arrest fracture vertical growth by forming a pack along the edge of the blade-like fracture tip. Depending on the buoyancy of the materials used, the upper, lower, or both of edges of the hydraulic fracture can be strengthened by this procedure.

In this method, a preliminary fracture is initiated at a low rate with a first low viscosity fluid. Second, solids of varying sizes are introduced into the fracture fluid at low concentrations, locking fracture geometry into place by deliberately packing the particles into the tip of the fracture. The placement and growth of the fracture largely depends on formation stress distribution across the depth and the propagation is affected by fracture toughness.

For a slowly advancing fracture, if the tip of the fracture is not wetted by the fracture fluid, the fracture toughness acts like a clamp, thus offering a resistance to propagation since the fluid lag region may have pressures similar to that of vapor pressure and cannot counter the process zone stresses. If, for such a slow advancing fracture, particulate matter is forced into the edges of the fracture in the near tip region, so as to form a tightly packed porous plug, movement of the fracture tip will be impeded since additional tip pressure will be required to push the pack away before additional rock can be wetted. Thus, the edge of the fracture is now temporarily strengthened, and the fracture contained.

In more detail, the method can be described in one embodiment as follows:

First, drill or otherwise provide a production well completed with multi-stage hydraulic fracturing so that in each stage, multiple transverse fractures are created by using multiple perforation clusters.

The well may be an existing well or a well completed specifically for this fracturing method. Horizontal wells are preferred, especially in shale plays, but vertical wells are sometimes used, as well as combinations of wells. Drilling multiple horizontal wells from a single pad has increasingly become a common approach for developing shale reservoirs due to significant cost, time, and environmental savings. Open hole or cased wells can be subjected to transverse fracking.

A fracture is initiated at a low pumping rate using a low viscosity fluid that maybe a linear gel or even brine water with solids suspension properties, and fracture geometry and growth rate are determined as taught herein or using any suitable method in the art. When a fracture geometry is determined to be problematic, such that tip strengthening is warranted to avoid unwanted fracture propagation, a small amount of tip strengthening material is pumped in to settle at fracture tips, the placement being controlled by the buoyancy or specific density of the solid used—buoyant solids packing upwardly growing tips, and sinking solids packing downwardly growing tips. These two types of solids in specific concentrations can be applied separately, or combined into a single step, depending on reservoir needs.

Tip strengthening is confirmed by monitoring pressure, wherein the slope of a log-log plot of pressure (x axis) versus time (y axis) is positive. A zero or negative slope indicates the need to slow the rate of pumping.

The tip strengthening step can optionally be repeated with a larger solid or higher concentration, further consolidating the tip. In yet another embodiment, the light and heavy solids can be combined in one step, and in another embodiment, the heavier solid may be combined with the main treatment plan.

Once the tips are strengthened in this way, the fracture plan can proceed as normal.

Ideally reservoir and fracture parameters will be entered into a reservoir model, so that fracture geometry can be predicted in advance of field use. The fracture plan can thus be optimized by iterated simulations, and the optimized plan implemented in a real reservoir and increased hydrocarbon produced.

As used herein a “tip strengthening material” can be any solid, non-dissolving material that deposits in the tip, preventing further propagation of that fracture. Such materials include proppant, ceramics, bauxite, crushed shells, chemicals that solidify when exposed to temperatures, and the like.

As used herein a “main treatment” injection comprises the usual techniques of hydraulic fracturing, typically including a pad injection, a proppant injection and a flush, but these may be varied as needed.

The issues that should be considered in designing a fracture job include the following:
Porosity and Permeability
Lateral Length
Brittleness vs. Ductility
Young's Modulus
Poisson's Ratio
Fracture Toughness
Thickness
Barriers
Depth
In-Situ Stress
Maximum Principal Stress Direction
Lithology of Pay
Stress Anisotropy
Natural Fractures
Gas or Liquids Reservoir
Temperature
Reservoir Pressure

It is known in the art how to maximize transverse fractures in shale. Multiple transverse hydraulic fractures are generated when all wellbores are drilled in the direction of the minimum horizontal stress. In this way, the maximum horizontal stress is perpendicular to the wellbore, and fractures will thus tend to occur in that direction, e.g., transverse to the wellbore.

Perforation cluster spacing and stage spacing are also important. Ideally, cluster spacing is on the order of 50-100 feet, and stage spacing is 250 to 500 feet, although some have reported better production with shorter spacings of 150 feet with a gross perforated interval of 100 ft (top perf to bottom pelf) with 31-ft perforation clusters, each spaced 50 ft apart.

Typically, there are 2-8 or 3-5 perforation clusters per stage, with 4-12 or 6-10 shots per foot, typically arranged in a spiral around the well bore with e.g., 60 degree spacing so that 1-2 foot of the bore is perforated in a cluster. Another option is to shoot 0-180° or in transverse planes. Typically, 3-5 stages are fractured (e.g., 3-5 zones). These ranges are exemplary only, and other spacings and numbers may be used depending on the reservoir characteristics.

The fracturing method can be any suitable method or combinations of methods, provided that multiple transverse fractures are the final result. Thus, the method could employ aspects of hydraulic fracking, thermal fracking, cryogenic fracking, electric fracking, explosive fracking, pneumatic fracking and the like, although hydraulic fracking, possibly combined with cryogenic fracking may be preferred, e.g., with liquid N₂, LNG, liquid CO₂, cold methanol, and the like.

Any preflush and afterflush procedures can be combined with the method. For example, preflush may be used to clean the rock and/or increase wettability. Afterflush may be used to clear out gels and other polymers. The person of ordinary skill in the art knows how to include such steps in a fracking plan, and these details are not discussed extensively herein.

Any suitable fracturing fluid can be used, although water-based frack fluids are probably preferred, possibly with polymers to increase viscosity for proppant mobility. A number of fluids are described in Table 1:

TABLE 1
Frack Fluids

| Base Fluid | Fluid Type | Main Composition |
|---|---|---|
| Water based | Slickwater | Water + sand (+chemical additives) |
| | Linear fluids | Gelled water, GUAR, HPG, HEC, CMHPG |
| | Cross-linked fluid | Crosslinker + GUAR, HPG, CMHPG, |
| | | CMHEC |
| | Viscoelastic surfactant gel | Electrolite + surfactant |
| | fluids | |
| Foam based | Water based foam | Water and Foamer + N₂ or CO₂ |
| | Acid based foam | Acid and Foamer + N₂ |
| | Alcohol based foam | Methanol and Foamer + N₂ |
| Oil based | Linear fluids | Oil, Gelled Oil |
| | Cross-linked fluid | Phosphate Ester Gels |
| | Water emulsion | Water + Oil + Emulsifiers |
| Acid based | Linear | — |
| | Cross-linked | — |
| | Oil emulsion | — |
| Alcohol based | Methanol/water mixes or | Methanol + water |
| | 100% methanol | |
| Emulsion based | Water-oil emulsions | Water + Oil |
| | CO₂-methanol | CO₂ + water + methanol |
| | Others | — |
| Other fluids | Liquid CO₂₋ | CO₂ |
| | Liquid nitrogen | N₂ |
| | Liquid helium | He |
| | Liquid natural gas | LNG (butane and/or propane) |

A variety of proppants can be used in the method. Proppants are small crush-resistant particles that are carried into the fractures by the hydraulic fracturing fluid. When the pumps are turned off and the fractures collapse these crush-resistant particles hold the fracture open, creating pore space through which natural gas can travel to the well.

Frac sand is the proppant most commonly used today, but aluminum beads, ceramic beads, sintered bauxite, crushed shells, and other materials have also been used. Over one million pounds of proppants can be used while fracturing a single well. Proppant use can also be reduced in carbonate/dolomite plays where acid etching is used.

Herein the tip strengthening material is essentially the same material that is used as a proppant, but its use differs in that smaller grain (e.g. 100 US Mesh or 40/70 US Mesh) and heavier material are used for downward propagating loss, with smaller grains and less dense materials used for upward propagating loss. Note that following the basic Stokes' Law, fluids with lower viscosity will facilitate rapid settling of proppant and ensuing pressure from the next injection cycle will consolidate the packing. Other dependencies of settling velocities are directly proportional to density difference between proppant and fluid density and also have a direct dependence on the square power of diameter of the proppant.

Corrosion inhibitors, demulsifiers, surface tension reducing agents, chemical retarding agents, clay stabilizers, friction reducers and other additives referred to above may be incorporated in the fracturing fluid if desired. Care should again be taken that the additives selected are compatible with the other components, as well as with the carrier fluid. Some commonly used additives are described below:

Surfactants: Surfactants are used to reduce surface and interfacial tension, to prevent emulsions, to water wet the formation, and to safeguard against other associated problems. Swabbing and clean-up time can be reduced by lowering surface tension.

Suspending Agents: Agents to suspend fines. Suspension should be differentiated from dispersion. Dispersed particles usually settle in a short time. Care should be taken that suspending agents do not interfere with the tip strengthening material, but usually the tip strengthening material will be too large to be affected.

Sequestering Agents: Sequestering agents act to complex ions of iron and other metallic salts to inhibit precipitation of iron. Sequestering agents are typically used if rusty tubing or casing is to be contacted.

Anti-Sludge Agents: Some crudes, particularly heavy asphaltic crudes, from an insoluble sludge when contacted with acid. The primary ingredients of a sludge are usually asphaltenes, but sludges may also contain resins and paraffin waxes, high-molecular weight hydrocarbons, and formation fines or clays. Addition of certain surfactants can prevent sludge formation by keeping colloidal material dispersed.

Corrosion Inhibitors: Corrosion inhibitors temporarily slow down the reaction of acid on metal. Corrosion inhibition time varies with temperature, acid concentration, type of steel, and inhibitor concentration. Both organic and inorganic corrosion inhibitors have application in acidizing. Some organic inhibitors are effective up to the 300° F. range. Extenders have been developed to increase the effective range to 400° F. Inorganic arsenic inhibitor can be used up to at least 450° F.

Alcohol: Normally methyl or isopropyl alcohol in concentrations of 5% to 30% by volume can be used to lower surface tension. The use of alcohol in acid will accelerate the rate of well clean-up and improve clean-up, particularly in dry gas wells. Disadvantages are increased inhibitor problems and possible salt precipitation.

Fluid Loss Control Agents: Fluid loss control agents may be required to reduce leak-off, particularly in fracture acidizing. The preferred method of selecting fluid loss control agents is to run fluid loss tests on cores from the formation to be fracked.

Diverting or Bridging Agents: Fluids will usually follow the path of least resistance, usually the lesser damaged intervals, unless diverting or bridging agents are employed to allow relatively uniform treatment of various porous zones open to the wellbore. Diverting or bridging agents are distinct from the tip strengthening materials in their usage, such that diverting or bridging agents are gels that solidify to form impervious barriers. These barriers are set in the flow path by first pumping the gelling components into the reservoir, providing an activator or other condition required for setting, and allowing the agent to set in the flow path.

The invention includes the following one or more embodiments, in any combination thereof:

A method of stimulating a reservoir for increased production of hydrocarbons, said method comprising:
a) injecting a fracture fluid into a stage of a well in a reservoir to initiate one or more fractures in said
stage;
b) determining a fracture extension rate and a primary fracture geometry and identifying one or more
fracture tip(s) that require strengthening;
c) injecting a first tip strengthening fluid containing a first non-dissolving solid into said stage at a first
rate such that a slope of a log-log plot of net pressure versus time is positive and said one or more
fracture tip(s) are strengthened by depositing said first solid into said one or more fracture tip(s);
d) optionally repeating step c) with a second tip strengthening fluid containing a second non-dissolving
solid that is larger than said first non-dissolving solid;
e) injecting a main treatment injection fluid at a second rate that does not exceed said first rate once it is
determined from injection pressure diagnostics that the fracture tips are strengthened and the fracture
vertical growth is contained during the injection;
f) repeating steps a-e) for subsequent stages of said well; and
g) producing hydrocarbons from said well.
Any method herein described wherein the optional repeating step is performed.
Any method herein described wherein the optional repeating step is omitted and instead said second tip
strengthening fluid is combined with said main treatment injection fluid.
Any method herein described wherein the first and second tip strengthening injection steps are combined
and said first and second solids are in a 60/40 to 40/60 ratio or in a 50/50 ratio.
Any method herein described, wherein a main treatment comprises a first pad injection followed by a
proppant injection and a final flush injection.
Any method herein described wherein said first solid is 40/70 US mesh sand or 30/50 US mesh sand, or
wherein said second solid is 100 US mesh sand, or both.
Any method herein described wherein 100 US mesh sand is pumped with said main treatment at 0.5 lbm/gal
concentration.
Any method herein described, wherein i) said one or more fracture tips are predominantly downward
growing fracture tips and said first and second solids are heavier than said injection fluid and sink, or
wherein ii) said one or more fracture tips are predominantly upward growing fracture tips and said first
and second solids are lighter than said injection fluid and float or are neutral buoyant, or iii) said solids
are of mixed buoyancy or both i) and ii).
Any method herein described, where a flush fluid is injected after one or more or each of the injection
steps.
Any method herein described, wherein said method is preceded by simulating fracture geometry in a model
reservoir having characteristics of said reservoir to identify said one or more fracture tip(s) that require
strengthening.
Any method herein described wherein solid settling is simulated in said model reservoir.

A “fracture” is a crack, delamination, surface breakage, separation or other destruction within a geologic formation or fraction of formation not related to foliation or cleavage in metamorphic formation, along which there has been displacement or movement relative to an adjacent portion of the formation. A fracture along which there has been lateral displacement may be termed a fault. When walls of a fracture have moved only normal to each other, the fracture may be termed a joint. Fractures may enhance permeability of rocks greatly by connecting pores together, and for that reason, joints and faults may be induced mechanically in some reservoirs in order to increase fluid flow. Fractures may also be natural.

A “transverse fracture” is a fracture that is more than 15 degrees deviated from the axis of the wellbore and is usually roughly perpendicular thereto. A “longitudinal” or “axial” fracture is oriented 15 degrees or less from the axis of the wellbore, e.g., substantially parallel to the wellbore.

A “hydraulic fracture” is a fracture at least partially propagated into a formation, wherein the fracture is created through injection of pressurized fluids into the formation. While the term “hydraulic fracture” is used, the techniques described herein are not limited to use in hydraulic fractures. The techniques may be suitable for use in any fractures created in any manner considered suitable by one skilled in the art. Hydraulic fractures may be substantially horizontal in orientation, substantially vertical in orientation, or oriented along any other plane. Generally, the fractures tend to be vertical at greater depths, due to the increased mass of the overburden.

As used herein, “hydraulic fracturing” is a process used to create fractures that extend from the wellbore into formations to stimulate the potential for production. A fracturing fluid, typically viscous, is generally injected into the formation with sufficient pressure, for example, at a pressure greater than the lithostatic pressure of the formation, to create and extend a fracture. A proppant may often be used to “prop” or hold open the created fracture after the hydraulic pressure used to generate the fracture has been released. Parameters that may be useful for controlling the fracturing process include the pressure of the hydraulic fluid, the viscosity of the hydraulic fluid, the mass flow rate of the hydraulic fluid, the amount of proppant, and the like.

“Overburden” refers to the subsurface formation overlying the formation containing one or more hydrocarbon-bearing zones (the reservoirs). For example, overburden may include rock, shale, mudstone, or wet/tight carbonate (such as an impermeable carbonate without hydrocarbons). An overburden may include a hydrocarbon-containing layer that is relatively impermeable. In some cases, the overburden may be permeable.

“Overburden stress” refers to the load per unit area or stress overlying an area or point of interest in the subsurface from the weight of the overlying sediments and fluids. In one or more embodiments, the “overburden stress” is the load per unit area or stress overlying the hydrocarbon-bearing zone that is being conditioned or produced according to the embodiments described. In general, the magnitude of the overburden stress may primarily depend on two factors: 1) the composition of the overlying sediments and fluids, and 2) the depth of the subsurface area or formation.

Similarly, “underburden” refers to the subsurface formation underneath the formation containing one or more hydrocarbon-bearing zones (reservoirs).

“Permeability” is the capacity of a formation to transmit fluids through the interconnected pore spaces of the rock. Permeability may be measured using Darcy's Law: Q=(k ΔP A)/(μL), where Q=flow rate (cm³/s), ΔP=pressure drop (atm) across a cylinder having a length L (cm) and a cross-sectional area A (cm₂), μ=fluid viscosity (cp), and k=permeability (Darcy). The customary unit of measurement for permeability is the millidarcy.

The term “relatively permeable” is defined, with respect to formations or portions thereof, as an average permeability of 10 millidarcy or more (for example, 10 or 100 millidarcy). The term “relatively low permeability” is defined, with respect to formations or portions thereof, as an average permeability of less than about 10 millidarcy. An impermeable layer generally has a permeability of less than about 0.1 millidarcy. By these definitions, shale may be considered impermeable, for example, ranging from about 0.1 millidarcy (100 microdarcy) to as low as 0.00001 millidarcy (10 nanodarcy).

“Porosity” is defined as the ratio of the volume of pore space to the total bulk volume of the material expressed in percent. Although there often is an apparent close relationship between porosity and permeability, because a highly porous formation may be highly permeable, there is no real relationship between the two—a formation with a high percentage of porosity may be very impermeable because of a lack of communication between the individual pores, capillary size of the pore space or the morphology of structures constituting the pore space. For example, the diatomite in one exemplary formation type—Belridge—has very high porosity, at about 60%, but the permeability is very low, for example, less than about 0.1 millidarcy.

As used herein, “shale” is a fine-grained clastic sedimentary formation with a mean grain size of less than 0.0625 mm. Shale typically includes laminated and fissile siltstones and claystones. These materials may be formed from clays, quartz, and other minerals that are found in finegrained rocks. Non-limiting examples of shales include Barnett, Fayetteville, and Woodford in North America. Shale has low matrix permeability, so production in commercial quantities requires fracking to provide permeability. Shale reservoirs may be hydraulically fractured as described herein to create extensive artificial fracture networks around wellbores. Horizontal drilling is often used with shale wells.

“Stimulated reservoir volume” or “SRV” is used to describe the shape and size of a fracture network created by hydraulic or other induced fracturing in low-permeability reservoirs.

As used herein, a “step rate test” or “SRT” is where an injection fluid is injected for a defined period in a series of increasing pump rates. The resulting data are used to identify key treatment parameters of the fracturing operation, such as the pressure and flow rates required to successfully complete the treatment. The SRT can be performed by the methods described at rrc.texas.gov/oil-and-gas/publications-and-notices/manuals/injection-disposal-well-manual/summary-of-standards-and-procedures/technical-review/step-rate-test-guidelines/or epa.gov/sites/default/files/documents/INFO-StepRateTest.pdf, although different jurisdictions may require different variations of these tests.

As used herein a “dedicated calibration injection test” is a constant rate injection test with actual fracturing fluid and is oft performed by a service company or others who own injection pumps and are able to record the injection rate and pressure data.

As used herein, a “pressure fall-off test” is the measurement and analysis of pressure data taken after an injection well is shut in. The falloff period is a replay of the injection preceding it. Consequently, it is impacted by the magnitude, length, and rate fluctuations of the injection period and any fractures. Falloff testing analysis provides transmissibility, skin factor, and well flowing and static pressures. An EPA test for region 6 is provided at epa.gov/sites/default/files/2015-07/documents/guideline.pdf. As above, different jurisdictions may require different variations of this test.

A “production well” or “producer” is completed for production, and an “injection well” or “injector” completed for injection. It is possible to convert from one type of completion to the other. For example, the lower injector well is converted to production once the wells in a SAGD wellpair are in fluid communication, but during start-up, both wells are completed for injection and steam is injected into both.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

The phrase “consisting of” is closed, and excludes all additional elements.

The phrase “consisting essentially of” excludes additional material elements, but allows the inclusions of non-material elements that do not substantially change the nature of the invention, such as additives, preflush fluids or steps, afterflush fluids or steps, and the like.

The following abbreviations may be used herein:

| ABBREVIATION | TERM |
|---|---|
| BBL | Barrel |
| CMHEC | Cyclomethyl Hydroxyethyl cellulose |
| CMHPG | Carboxymethyl Hydroxypropyl guar |
| Frac | Short for fracture, see also fracking |
| Fracking | Refers to fracturing a reservoir, e.g., inducing fracture formation |
| Ft | Feet |
| HEC | Hydroxyethyl Cellulose |
| HPG | Hydroxypropyl guar |
| Lbm | Pounds mass |
| LPG | Liquefied petroleum gas, also LP gas or condensate |
| LNG | Liquefied Natural Gas |
| M | Meters |
| mD | milliDarcy |
| MGAL | Thousand gallons |
| Pc | Closure pressure-defined as the fluid pressure at which an existing |
| | fracture globally closes. Commonly determined by G-function plot |
| | or superposition G*dP/dG plot, with pressure data in y-axis and |
| | time-dependent G-Function on x-axis. The derivative is imposed in |
| | the same plot. Other methods include log-log plot of pressure fall- |
| | off versus time, or a square root plot -when the square root of time |
| | (x-axis) vs the bottom-hole pressure (y-axis) is plotted, the linear |
| | portion of the plot will lie along a straight line going through the |
| | origin. |
| PPA | Pounds of proppant added per gallon of fluid, also PPG pounds per |
| | gallon |
| PSI | Pounds per square inch |
| SAGD | Steam assisted gravity drainage |
| SI | Shut in |
| SRT | Step rate test-a method used to accurately measure the fracture |
| | pressure (or formation parting pressure) of a given geologic |
| | formation. The test is conducted by stepwise injections of fluid into |
| | the formation at a series of increasing rates, allowing each rate to |
| | stabilize, and noting the stabilized injection pressure for each rate. |
| | A plot of injection pressure versus injection rate is then made to |
| | identify the fracture pressure. |
| SRV | Stimulated reservoir volume |
| TVD | True vertical depth |

### BRIEF DESCRIPTION OF THE DRAWINGS

FIG. 1: (prior art) Hydraulic fracturing of a reservoir. Allows more gas or oil to reach the well for production.

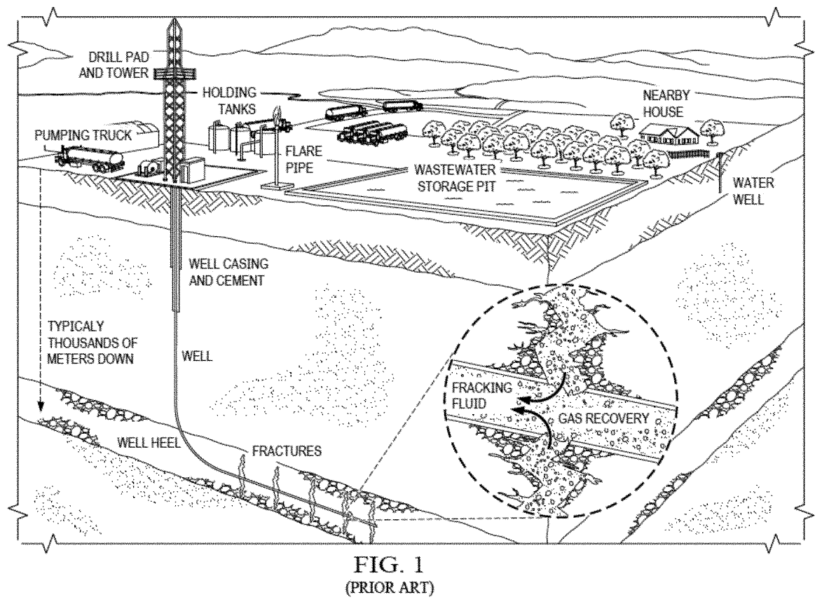

FIG. 2: (prior art) Well bore contact with various fracture types. Longitudinal open-hole (top), longitudinal cemented (center), and transverse fractures (bottom).

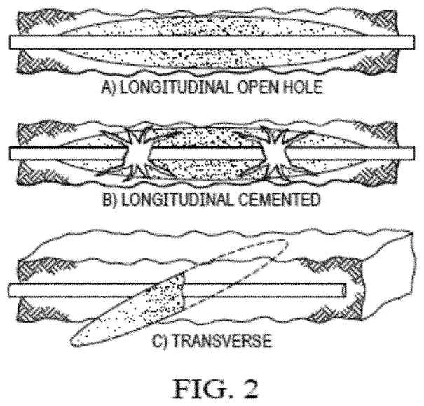

FIG. 3A-B: Fracture distance versus net pressure mapping. Graphs prepared using a simulator and a model that comprises a coal bed methane reservoir of permeability of 0.12 md, expected fracture conductivity of nearly 1,750 md-ft, pay zone between 3,325 and 3,375 ft (1,014.7 and 1,029.0 m) and high mobile water saturation zone below 3,425 ft (1,044 m). FIG. 3A is net pressure in psi on the x axis versus distance in feet from the fracture initiation point (0) on the y axis. The circle (top line) and squares (bottom line) indicating the upper and lower tips of the fracture, respectively. The middle of the fracture is shown by triangles (middle line). FIG. 3B is stress distribution of the formation as a function of depth. Stresses are indicated by the circles with a range of psi shown, and the star indicates a perforation cluster. In FIG. 3A, the star denotes the distance of the high stress member from the center of the perforation and aligns with the depth position in FIG. 3B. The payzone and high water saturation region are highlighted by top and bottom boxes, respectively.

FIG. 4A-B: Simulation shows possible downward growth of fracture into unwanted zones. FIG. 4A is stress in psi versus true vertical depth (“TVD”) in meters with the black line indicating formation stresses in psi and the colors showing various layer types. These are yellow, red, purple and gray for clean-sandstone, dirty-sandstone, siltstone and shale respectively. FIG. 4B is fracture penetration in meters versus TVD wherein the colors represent proppant coverage in lb/ft2. The high water saturation zone is shown by the blue box.

FIG. 5A-B: Simulation depicting proppant settling at the bottom of the fracture. FIG. 5A is the modeled stress distribution of the various layers in the formation and FIG. 5B is fracture half-length showing proppant coverage. In FIG. 5, the simulation shows higher concentrations of proppant depicted by blue color and equivalent to nearly 0.2 lbm/ft₂ based on the scale on right Y-axis, at the bottom tip of the fracture. The arrows inside the fracture show the direction and magnitude of fluid velocity vector that can be scaled based on scale of “0.419 m/s” shown at the bottom of the proppant coverage scale. The fracture half-length is limited to 100 m.

FIG. 6A-B: Simulation depicting proppant settling at the bottom of the fracture. FIG. 6A is the modeled stress distribution of the various layers in the formation and FIG. 6B is fracture half-length showing proppant coverage. This plot shows that after strengthening the bottom tip of the fracture, the fracture can now be extended to the desired fracture half-length, and it will not grow into the high water saturation layers below thus helping to meet the objective of the fracture simulation treatment.

### DETAILED DESCRIPTION

In order to obtain proof of concept for the methods, we performed simulations of a model coal bed methane gas well with a low permeability of 0.12 mD and expected fracture conductivity of nearly 1,750 mD-ft. Given these constraints, a propped fracture half-length of nearly 300 meters is desirable if a dimensionless fracture conductivity of 15 is targeted for optimal well performance. The objective of the treatment was to limit the fracture growth within the pay zone between 3,325 and 3,375 ft (1,014.7 and 1,029.0 m) and fractures must be prevented from entering the high mobile water saturation zone below 3,425 ft (1,044 m).

The gridded numerical model was run in a fully 3-dimensional mode and took into account a 2-dimensional fluid flow inside the fracture, which accounts for proppant settling mechanism while also accounting for leakoff of fluid into the formation, which is a critical input in calculation of fracture geometry.

Simulations were performed with a fluid of small viscosity of up to 12 cP and injection rates of nearly 8 bbl/min.

Following are the steps used in our proof-of-concept work, wherein we first simulated fracture geometry under a more traditional injection profile, and then tested one embodiment of the inventive profile. Once an injection profile is optimized by simulator, it can then be applied with the field.

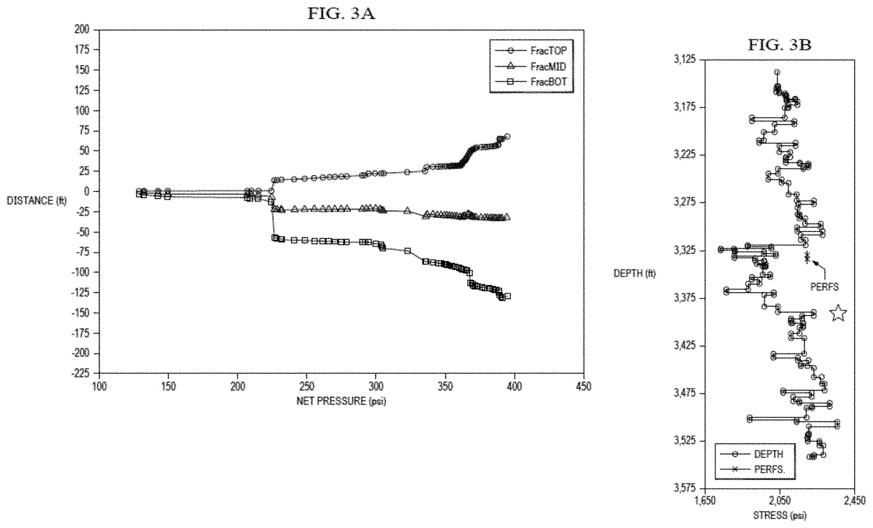

Determine fracture vertical growth profile. The plot of distance versus net pressure in FIG. 3A is generated using the technique discussed in Pandey and Rasouli (2021), where the apparent fracture toughness was input based on the model developed to calculate the same with the help of predicted fluid velocity. The distribution of in situ stresses in the model formation did not favor a well contained fracture due to the presence of low-stressed members below the depth of 3,395 ft, as shown in the right plot of FIG. 3B.

FIG. 3A confirms that if the net pressure during the treatment (defined as fracture pressure minus in situ stress) exceeds 350 psi, the bottom stress barrier at this depth is liable to give in. As a result, the fracture can migrate downwards, as shown by the location bottom tip of the fracture in FIG. 3A. The points in 3A denote the expected top, middle and bottom tips of the fracture. As can be seen, initially the top and bottom of the fractures remained confined to a total height of a mere few feet if the net pressures are limited to 225 psi. Once the net pressures exceed 225 psi, the fracture appears to grow in downward direction, nearly 60 ft below the initiation point and with further increases in net pressure, tends to grow vertically in both the directions, as shown by upper and lower tip location. The depth and distances are both highlighted by a star and the payzone and the high water saturation region, are highlighted by top and bottom boxes, respectively.

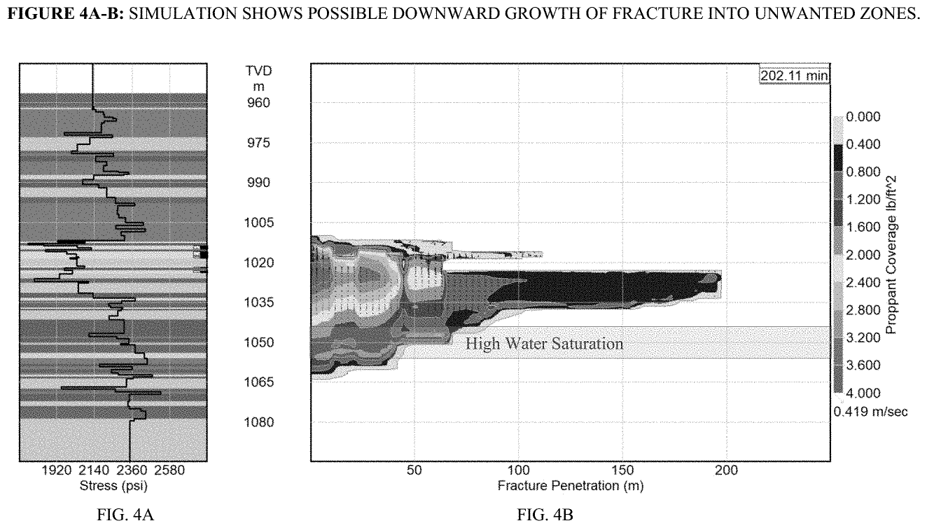

Simulate base fracture treatment to obtain fracture geometry. The fracture geometry plot generated by a gridded numerical fracture simulator for a typical pump schedule is shown in FIG. 4. The plot of FIG. 4A shows typical output from a fracture simulator where one of the 2 equally sized fracture wings (bi-wing fracture) is illustrated with for a given fracture property along the vertical height and half-length of the fracture. The track on the left shows stress distribution in the formation as a function of depth, and the various colors represent various layer lithological types described above. The right portion of the plot shows the extent of fracture extension and height growth, with the various colors depicting the contour of proppant coverage inside the fracture with the units of lbm/ft². The small arrow shows the velocity vectors associated with fluid movements inside the fracture. The vectors can be scaled from the scale shown on the bottom of the right legend. The same implies for FIG. 4B.

A crosslinked frac fluid of 20 lbm/Mgal concentration was used in the simulation and the injection rates were limited to 12.0 bbl/min to ensure that net pressures were under control and excessive height growth avoided. For a payzone of nearly 40 ft (12.2 m) the total proppant designed was 145,000 lbm reaching up to a maximum concentration of 8.0 lbm/gal to generate the desired conductivity.

As expected, the simulation confirms that a downward fracture growth is possible, despite our viscosity and rate precautions, since the bottom barrier is not sufficiently strong to contain the fracture. The downward fracture growth results in the fracture contacting non-pay rock and considerable placement of proppant in regions that will not contribute to production. Also, the penetration of the fracture in rocks with high mobile-water saturation below 1,044 m (3,425 ft) may also make the well more prone to water production.

Since the typical frack injection profile was clearly not optimized for our model reservoir, we next simulated a frack technique wherein fracture tips were strengthened with solid material, thus restraining fracture growth, before a similar main fracking plan was implemented.

Employ the Specialized Pumping Technique to Halt Downward Fracture Growth.

To arrest fracture growth in downward direction (as needed for this exemplary reservoir), we simulated the same model well using one example of the inventive injection profile (see below). Where successful in the simulation, the same steps are to be followed in a reservoir having the same parameters that were simulated in the successful model.

Preferably, bottomhole pressure data is either obtained with the help of downhole gauges or with the help of calculated bottomhole pressures and used to control the rates of injection and thus pressures to achieve our tip strengthening goals.

In general, the procedure laid out below outlines the process of strengthening the blade-like edge of the entire fracture and concentrated at the fracture tips with preparatory steps shown below. Once this action is done, the actual planned fracking treatment, termed as “main treatment” will be pumped with an intention to fracture stimulate the well. The observations of rate and pressure made during the fracture tip strengthening process will influence the main treatment design.

1) Breakdown the formation at a low injection rate not exceeding 5.0 bbl/min (0.8 m₃/min), pump-in additional 10 bbl (1.59 m³) and shut-in the well to monitor the pressure decline to identify the closure pressure (Pc). The injection fluid should be a linear gel (non-crosslinked fluid) of small polymer loading such as 10 to 15 lbm/Mgal with viscosity in the range of 10 to 13 cP.

2) Once Pc is determined, conduct a step rate test (“SRT”) with 15 lbm/Mgal (or thereabouts) linear gel or the type/polymer loading mentioned in step 1 to identify the fracture extension rate. Limit the maximum rate during the SRT to not more than twice the injection rate or 8.0 bbl/min (1.27 m3/min). Shut-in the well to obtain closure pressure and identify any change from previous value.

3) Conduct a dedicated calibration injection test at the maximum rate during Step 2. Identify injection pressure profile i.e., the slope of net pressure versus time in log-log plot to determine geometry—whether the fracture is extending or increasing in height or if it is a radial fracture. Determine fracture closure pressure Pc from pressure fall-off after shut-in of injection test to determine the net pressure gain, formation leakoff, Young's Modulus, and fluid efficiency. Care must be taken to conduct this test with a linear gel of 10 to 15 lbm/Mgal specified above to limit the net pressures.

4) Analyze the bottomhole injection pressures in Step 3 to determine the primary geometry and perform a pressure fall-off test to determine if fracture height growth was observed, which should generally be the case if a lack of barrier is suspected.

5) Conduct a sand settling test with 100, 40/70 and 30/50 U.S. Mesh at 0.25 and 0.5 lbm/gal concentration in 10 lbm/Mgal and 15 lbm/Mgal linear gel fluids. Note down the settling times and select the fluid/sand concentration combination that results in faster setting for first cycle of fracture containment mentioned in step 6) below.

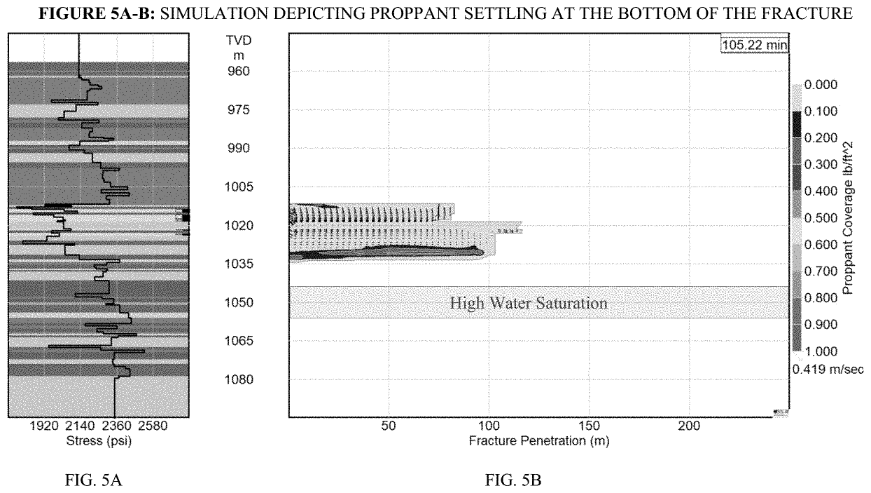

6) Inject the fracture containment treatment using the combination identified in step 5). This will consist of low viscosity fluid, such as 15 lbm/Mgal linear gel with breakers where the total injection volume does not exceed 50% of the planned pad volume of the main treatment which is the actual fracture stimulation treatment planned for the well (see 0092). We used the following schedule (Table 2), wherein our tests showed that 40/70 U.S. mesh or 30/50 U.S. mesh may be pumped, but the data in FIG. 5 was generated with 100 mesh in small concentrations of 0.5 lbm/gal.

The slurry (fluid+solids) laden fluid must be flushed into the formation with the same linear gel, but over-flushing must be avoided. A freeze protect fluid may be pumped as the end of flush if the wells are in colder regions.

TABLE 2
Pump Schedule for Fracture Containment Treatment - Part I.
SI = Shut in

| | | Rate | | | |
|---|---|---|---|---|---|
| Step | Name | (bbl/min) | Volume | Solid | Solid Conc. |
| 1 | Linear Gel | 6.0 | 15% Pad | None | None |
| 2 | Linear Gel | 6.0 | 35% Pad | 40/70 | 0.5 PPA |
| | | | | mesh | |
| 3 | Flush/SI | 0 | Wellbore | None | None |

7) Shut-in the well and again monitor the decline in pressure. The low viscosity fluid will allow quick settling of proppant and facilitate forming a proppant pack at the bottom edge of the fracture as shown in FIG. 5B. Continue to monitor the pressure until a closure is observed.

In our simulated model, downward growth was the problem, so we selected sands of 2.65 specific gravity to strengthen the bottom fracture barrier, or any specific gravity sufficient to allow the proppant to sink in the injection fluid being used. However, if the upward growth was problematic, neutrally buoyant or light weight proppant (such that the proppant tends to float in the injection fluid) may be pumped so strengthen upwardly growing fracture tips.

Pressure should be monitored closely during the injection period particularly when proppant is being in pumped. Where a ⅛ to ¼ slope can be identified in a log-log plot of net pressure versus time, there is sufficient indication that the fracture is now bound. If the slope is near zero or trending in the negative direction, the injection rate is reduced until a positive slope is observed.

8) Optionally repeat the fracture containment treatment shown in Step 5, but replace the 30/50 or 40/70 U.S. mesh sand with 100 mesh sand as follows (Table 3).

TABLE 3
Pump Schedule for Fracture Containment Treatment - Part II.

| | | Rate | | | |
|---|---|---|---|---|---|
| Step | Name | (bbl/min) | Volume | Solid | Solid Conc. |
| 1 | Linear Gel | 6.0 | 15% Pad | None | None |
| 2 | Linear Gel | 6.0 | 35% Pad | 100 mesh | 0.5 PPA |
| 3 | Flush/SI | 0 | Wellbore | None | None |

9) Shut-in the well and again monitor the decline in pressure. The 100-mesh sand will settle to the bottom of the fracture and consolidate the pack, especially when the actual hydraulic fracture stimulation is pumped after these preparatory fracture tip strengthening injection sequences. The 2-step fracture containment treatment (step 5 and step 7) offer double consolidation of the pack.

10) Pump the designed fracture stimulation treatment at controlled injection rates, especially in pad stage, so that the fracture remains confined. In the pad stage of the treatment, the injection rates must not increase the rates at which the fracture containment treatments were pumped. The pad may consist of low gel loading cross linked fluid such as 20 lbm/Mgal borate cross linked fluid used in the simulation of example case and hence will be prone to generating net pressures. Use plots such as shown in FIG. 3A as guidelines to limit net pressures while constantly monitoring them.

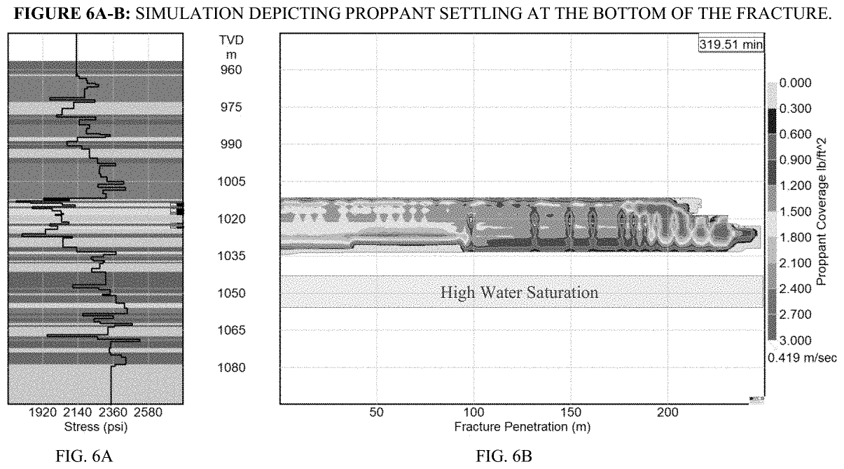

If the fracture containment is successful, the final fracture geometry may be similar to the illustration shown in the simulations results shown in FIG. 6.

The advantages of the new method may include one or more of the following in any combination(s) thereof:
Allow more precise placement of fractures.
Improve the probability of placing optimal fractures with desired length and fracture conductivity and within the payzone.
Prevent fractures from growing out of the payzone, especially into unwanted formations.
Improve overall well performance.

The following references are incorporated by reference in their entirety for all purposes.
PANDEY, V. J; AGREDA, A. J. (2014) New fracture-stimulation designs and completion techniques result in better performance of shallow Chittim ranch wells. SPE Prod & Oper 29 (4): 288-309. SPE-147389-PA. http://dx.doi.org/10.2118/147389-PA
PANDEY, V. J.; RASOULI, V. (2021) Vertical growth of hydraulic fractures in layered formations. Presented at The Virtual SPE Hydraulic Fracturing Technology Conference, 4-6 May. SPE-204155-MS. dx.doi.org/10.2118/204155-MS.
PANDEY, V. J.; RASOULI, V. (2021) A semi-analytical model for estimation of hydraulic fracture height growth calibrated with field data. J. Pet. Sci. and Eng. Volume 202, July 2021, 108503. doi.org/10.1016/j.petro1.2021.108503
PANDEY, V. J.; RASOULI, V. (2021) Fracture height growth prediction using fluid velocity based apparent fracture toughness model. Rock Mech. Rock Engg. J. doi. org/10.1007/s00603-021-02489-w.
PANDEY, V. J.; FLOTTMANN, T. (2015) Applications of geomechanics to hydraulic fracturing: case studies from coal stimulations. Presented at the SPE Hydraulic Fracturing Technology Conference, The Woodlands, Texas, 3-5 February. SPE-173378-MS. doi.org/10.2118/173378-MS,
MEYER B. R., BAZAN, L. W.; JACOT, H.; LATTIBEAUDIERE, M. G. (2010) Optimization of multiple transverse hydraulic fractures in horizontal wellbores. Presented at the SPE Unconventional Gas Conference, Pittsburgh, Pennsylvania SPE-131732-MS.
YU, W.; SEPEHRNOORI, K (2013) Optimization of multiple hydraulically fractured horizontal wells in unconventional gas reservoirs. J. Petrol. Eng. Article ID 151898, available online at hindawi.com/journals/jpe/2013/151898/.
Step Rate Test (SRT) Guidelines—Texas, at rrc.texas.gov/oil-and-gas/publications-and-notices/manuals/injection-disposal-well-manual/summary-of-standards-and-procedures/technical-review/step-rate-test-guidelines/
Step Rate Test Procedure, at epa.gov/sites/default/files/documents/INFO-StepRateTest.pdf.
UIC pressure falloff testing guideline at epa.gov/sites/default/files/2015-07/documents/guideline.pdf.

1. A method of stimulating a reservoir for increased production of hydrocarbons, said method comprising:
a) injecting a fracture fluid into a stage of a well in a reservoir to initiate one or more fractures in said stage;
b) determine a fracture extension rate and a primary fracture geometry and identifying one or more fracture tip(s) that require strengthening;
c) injecting a first tip strengthening fluid containing a first non-dissolving solid into said stage at a first rate such that a slope of a log-log plot of net pressure versus time is positive and said one or more fracture tip(s) are strengthened by depositing said first solid into said one or more fracture tip(s);
d) optionally repeating step c) with a second tip strengthening fluid containing a second non-dissolving solid that is larger than said first non-dissolving solid;
e) injecting a main treatment injection fluid at a second rate that does not exceed said first rate once it is determined from injection pressure diagnostics that said one or more fracture tips are strengthened and fracture vertical growth is contained during said injecting;
f) repeating steps a-e) for subsequent stages of said well; and
g) producing hydrocarbons from said well.

2. The method of claim 1, wherein step d) is performed.

3. The method of claim 1, wherein step d) is omitted and instead said second tip strengthening fluid is combined with said main treatment injection fluid.

4. The method of claim 1, wherein step c) and d) are combined and said first and second solids are in a 60/40 to 40/60 ratio.

5. The method of claim 1, wherein step c) and d) are combined and said first and second solids are in a 50/50 ratio.

6. The method of claim 1, said main treatment comprising a first pad injection followed by a proppant injection and a final flush injection.

7. The method of claim 1, wherein said first solid is 40/70 US mesh sand or 30/50 US mesh sand.

8. The method of claim 1, wherein said second solid is 100 US mesh sand.

9. The method of claim 1, wherein 100 US mesh sand is pumped with said main treatment at 0.5 lbm/gal concentration.

10. The method of claim 1, wherein i) said one or more fracture tips are predominantly downward growing fracture tips and said first and second solids are heavier than said injection fluid and sink, or wherein ii) said one or more fracture tips are predominantly upward growing fracture tips and said first and second solids are lighter than said injection fluid and float or are neutral buoyant, or iii) both i) and ii).

11. The method of claim 1, where a flush fluid is injected after each of steps c) and optional d) and e).

12. The method of claim 1, wherein said method includes simulating fracture geometry in a model reservoir having characteristics of said reservoir to identify said one or more fracture tip(s) that require strengthening.

13. The method of claim 12, wherein solid settling is simulated in said model reservoir.

14. A method of stimulating a reservoir for increased production of hydrocarbon; said method comprising:
a) simulating fracture geometry in a model reservoir having characteristics of a reservoir to identify said one or more simulated fracture tip(s) that require strengthening;
b) simulating solid settling into said one or more simulated fracture tip(s) in said model reservoir;
c) repeated steps a and b as needed to select a first tip strengthening fluid containing a first solid, and optionally a second tip strengthening fluid containing a second solid larger than said first solid;
d) injecting a fracture fluid into a stage of a well in said reservoir to initiate one or more fractures in said stage;
e) injecting said first tip strengthening fluid containing said first solid into said stage at a first rate such that a slope of a log-log plot of net pressure versus time is positive and said one or more fracture tip(s) are strengthened by depositing said first solid into said one or more fracture tip(s);
f) optionally repeating step e) with said second tip strengthening fluid containing said second non-dissolving solid that is larger than said first non-dissolving solid;
g) injecting a main treatment injection fluid at a second rate that does not exceed said first rate;
h) repeating steps d-g) for subsequent stages of said well; and
i) producing hydrocarbons from said well.

15. The method of claim 14, wherein said one or more simulated fracture tips are predominantly downward growing fracture tips and said first and second solids are denser than said injection fluid and sink.

16. The method of claim 14, wherein said one or more simulated fracture tips are predominantly upward growing fracture tips and said first and second solids are less dense than said injection fluid and float or are neutral buoyant.

17. The method of claim 14, wherein said first and second solids are a mix of dense solids that sink and less dense solids that float or are neutral buoyant.

18. The method of claim 14, wherein step f) is performed.

19. The method of claim 14, wherein step f) is omitted and instead said second tip strengthening fluid is combined with said main treatment injection fluid.

20. The method of claim 14, wherein step e) and f) are combined and said first and second solids are in a 60/40 to 40/60 ratio.

21. An improved method of fracturing a reservoir for increased production of hydrocarbon, said method comprising injecting a pad into a well in a reservoir to create fractures, injecting proppant into said well and said fractures, and then producing hydrocarbon from said well, the improvement comprising:
a) simulating fracture geometry in a model reservoir having characteristics of said reservoir to identify said one or more simulated fracture tip(s) that require strengthening;
b) simulating solid settling into said one or more simulated fracture tip(s) in said model reservoir;
c) repeated steps a and b as needed to select a first tip strengthening fluid containing a first solid, and optionally a second tip strengthening fluid containing a second solid larger than said first solid;
d) injecting a fracture fluid into a well in said reservoir to initiate one or more fractures;
e) injecting said first tip strengthening fluid into said well at a first rate such that a slope of a log-log plot of net pressure versus time is positive and said one or more fracture tip(s) are strengthened by depositing said first solid into said one or more fracture tip(s) and optionally repeating with said second tip strengthening fluid;
f) subsequently injecting a pad into said reservoir to create further fractures;
g) injecting proppant into said fractures; and
h) thereafter producing hydrocarbon from said well.
